(19) United States
(12) Patent Application Publication
(10) Pub. No.: US 2026/0204828 A1
(43) Pub. Date: Jul. 16, 2026

(54) CONNECTOR

(71) Applicant: Yazaki Corporation, Tokyo (JP)

(72) Inventors: Yuuhei Takeshita, Makinohara-shi (JP); Koki Iwakura, Makinohara-shi (JP); Ayumu Ishakawa, Fujieda-shi (JP); Moeto Osawa, Fujieda-shi (JP)

(21) Appl. No.: 19/445,974

(22) Filed: Jan. 12, 2026

(30) Foreign Application Priority Data
Jan. 15, 2025 (JP) 2025-005243

(51) Int. Cl. H01R 13/424

(52) U.S. Cl. CPC H01R 13/424

(57) ABSTRACT

This connector includes a terminal fitting, a housing, and a seal member. The housing includes a first housing and a second housing. The first housing includes a first peripheral wall, a restriction bead, and a terminal restriction portion. The restriction bead protrudes from an outer periphery of the first peripheral wall to restrict displacement of the seal member on a side away from an attachment mating member. The terminal restriction portion restricts displacement of the terminal fitting in a direction along an extending direction of the first peripheral wall. The second housing includes a second peripheral wall and a terminal holding portion. The second peripheral wall restricts displacement of the seal member on a side close to the attachment mating member in a state of being coupled to the first housing. The terminal fitting is inserted into the terminal holding portion.

### BACKGROUND OF THE INVENTION

### Field of the Invention

The embodiments of the present invention relate to a connector.

Priority is claimed on Japanese Patent Application No. 2025-005243 filed in Japan on January 15, 2025, the content of which is incorporated herein by reference.

### Description of Related Art

As a connector used for connection of an electric device, a connector in which a terminal fitting is accommodated in a resin housing is known (see, for example, Patent Document 1).

In the connector described in Patent Document 1, a terminal fitting connected to an electric wire is inserted from the rear side of a resin housing, and the terminal fitting is accommodated in a terminal holding portion provided inside the housing. An insertion port into which a terminal of a mating connector is inserted is formed on a front wall of the terminal holding portion. In addition, an opening into which a terminal restriction block (spacer) is inserted is formed in part of the peripheral wall of the housing and the wall of the terminal holding portion. The terminal restriction block includes a locking portion that restricts movement of the terminal fitting in the extending direction. The locking portion of the terminal restriction block is inserted into the terminal holding portion from a direction substantially orthogonal to the extending direction of the terminal fitting through the opening. When the locking portion of the terminal restriction block is engaged with the terminal fitting, the movement of the terminal fitting in the extending direction is restricted by the locking portion. Therefore, for example, when the terminal fitting attempts to move backward due to pulling of the electric wire or the like, the movement of the terminal fitting is held back by the terminal restriction block, and the terminal fitting is restricted from coming off from the housing.

Patent Document 1: Japanese Unexamined Patent Application, First Publication No. 2014-207102

### SUMMARY OF THE INVENTION

In the connector described in Patent Document 1, it is necessary to insert the terminal restriction block from a direction substantially orthogonal to the extending direction of the terminal fitting through the opening formed in the peripheral wall of the housing and the wall of the terminal holding portion. However, for example, in a case where the connector is liquid-tightly fitted into the fitting hole of the attachment mating member (for example, a mating connector to be connected), it is necessary to mount the sealing member on the peripheral wall of the housing. In addition, it is also necessary to form a plurality of restriction beads (annular raised portions) on the outer surface of the peripheral wall of the housing in order to restrict the forward and backward movement of the seal member in the axial direction. For this reason, it is difficult to secure an opening for inserting the terminal restriction block in the peripheral wall of the housing.

In addition, in a case where the connector is used in the above-described application, a plurality of restriction beads is formed on the peripheral wall of the housing so as to be aligned in the axial direction. In this case, when the housing is molded, it is difficult to perform die splitting (die cutting) along the axial direction of the housing. Therefore, when the housing is molded, die splitting (die cutting) is performed along the radial direction of the housing. However, in this case, a parting line along the axial direction is likely to occur on the outer surface of the peripheral wall of the housing after molding. This parting line tends to hinder liquid-tightness between the seal member and the housing.

An embodiment provides a connector capable of reliably restricting displacement of a terminal fitting along an extending direction and capable of bringing a seal member into close contact with a peripheral wall of a housing in a preferable manner.

A connector according to one embodiment includes: a terminal fitting connected to an electric wire; a housing having a peripheral wall in which a fitting hole of an attachment mating member is fitted on an outer side, and in which the terminal fitting is locked; and a seal member that is mounted on an outer side of the peripheral wall of the housing and seals a space between the peripheral wall and the fitting hole, the housing includes: a first housing, and a separate second housing coupled to the first housing, the first housing includes: a first peripheral wall constituting part of the peripheral wall, a restriction bead protruding from an outer periphery of the first peripheral wall to restrict displacement of the seal member on a side away from the attachment mating member, and a terminal restriction portion that restricts displacement of the terminal fitting in a direction along an extending direction of the first peripheral wall, and the second housing includes: a second peripheral wall that constitutes a remaining part of the peripheral wall and restricts displacement of the seal member on a side close to the attachment mating member in a state of being coupled to the first housing, and a terminal holding portion into which the terminal fitting is inserted.

According to an embodiment, it is possible to reliably restrict displacement of a terminal fitting along an extending direction and bring a seal member into close contact with a peripheral wall of a housing in a preferable manner.

### BRIEF DESCRIPTION OF THE DRAWINGS

FIG. 1 is a perspective view of a connector according to an embodiment;

FIG. 2 is an exploded perspective view of the connector according to the embodiment;

FIG. 3 is a perspective view of the connector according to the embodiment from which some parts are removed;

FIG. 4 is a plan view of the connector according to the embodiment from which some parts are removed;

FIG. 5 is a front view of the connector according to the embodiment;

FIG. 6 is a side view of the connector according to the embodiment from which some parts are removed;

FIG. 7 is a cross-sectional view corresponding to a VII-VII cross section of FIG. 5 of the connector according to the embodiment;

FIG. 8 is a cross-sectional view corresponding to a VIII-VIII cross section of FIG. 6 of the connector according to the embodiment; and

FIG. 9 is a cross-sectional view corresponding to a IX-IX cross section of FIG. 5 of the connector according to the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. “Parallel”, “orthogonal”, or “the same” may include “substantially parallel”, “substantially orthogonal”, or “substantially the same”, respectively.

### Constitution of connector

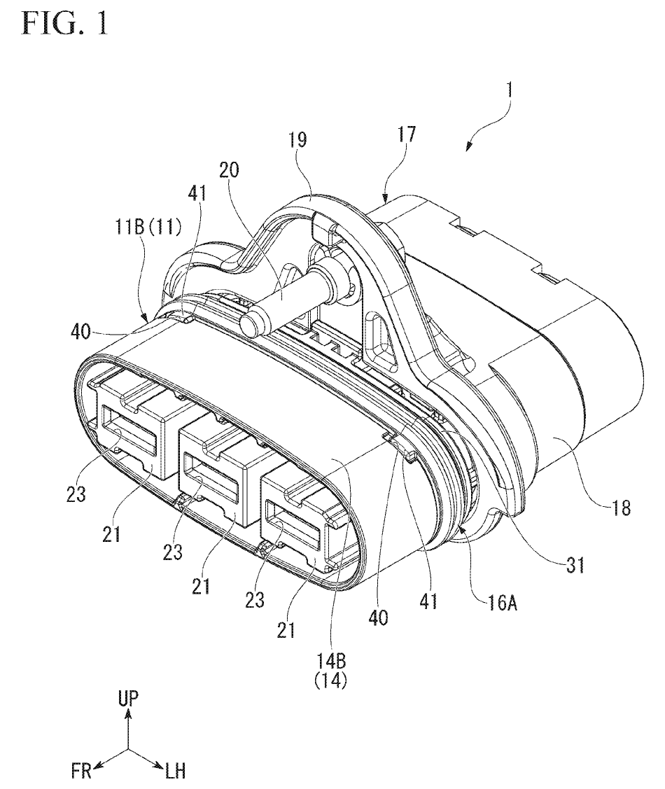

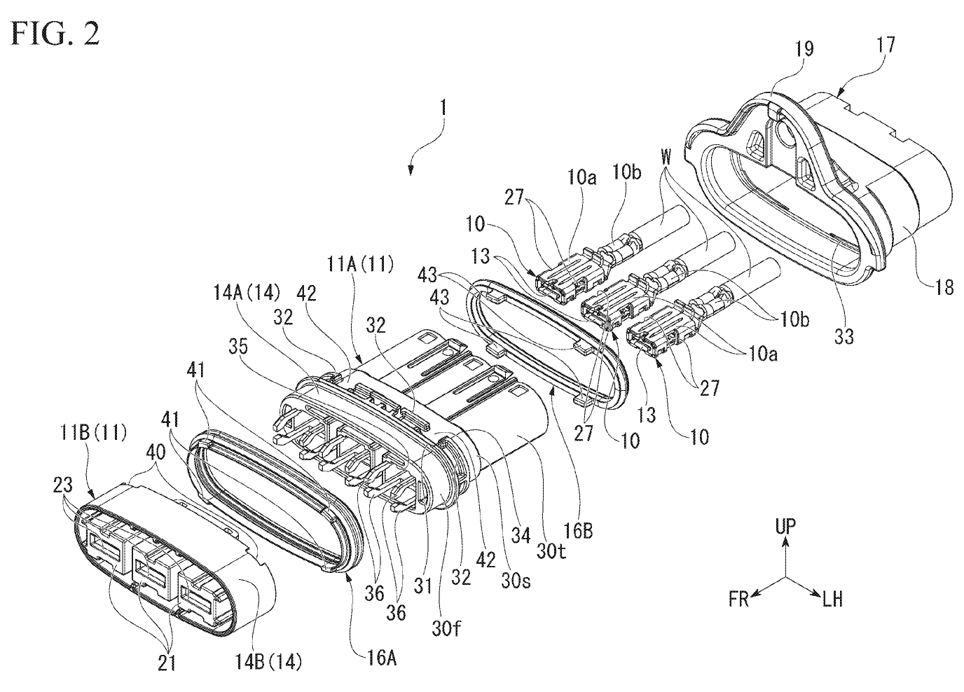

FIG. 1 is a perspective view of a connector 1 of the present embodiment. FIG. 2 is an exploded perspective view of the connector 1.

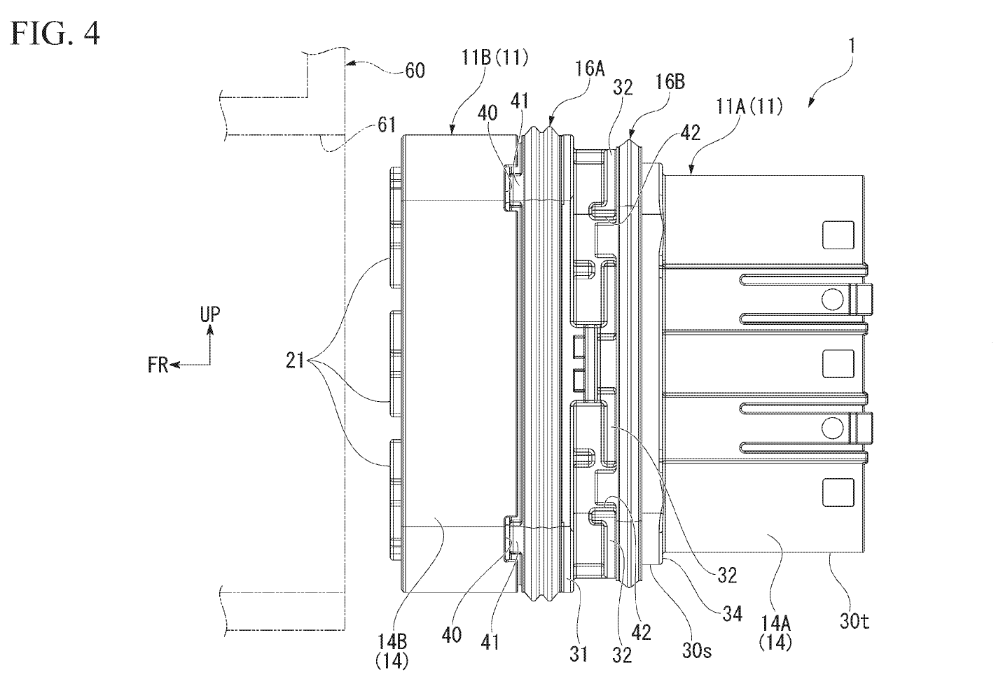

The connector 1 includes a plurality of terminal fittings 10 connected to an end portion of an electric wire W, a housing 11 in which the plurality of terminal fittings 10 is accommodated, and a connector cover 17 covering part of an outer peripheral portion of the housing 11. The housing 11 includes a peripheral wall 14 having a substantially oval shape in a front view. A fitting hole 61 (see FIG. 4) of a cover 60 of a mating connector (attachment mating member) is fitted to the outer side of the peripheral wall 14. In the present embodiment, three terminal fittings 10 having the same structure are accommodated in the housing 11. However, the number of terminal fittings 10 installed in the housing 11 is not limited to three. The number of terminal fittings 10 installed in the housing 11 may be four or more or two or less.

A mating terminal (male terminal) (not illustrated) can be inserted into the terminal fitting 10 on one end side in the longitudinal direction (the side opposite to the side to which the electric wire W is connected). The terminal fitting 10 of the present embodiment is a female terminal fitting that receives a male mating terminal. The mating terminal is brought into contact connection with the terminal fitting 10 and is electrically conducted. The terminal fitting 10 includes a terminal body portion 10a having a long rectangular parallelepiped shape elongated in one direction, and an electric wire connection portion 10b connected to the terminal body portion 10a and connected to an end portion of the electric wire W. In the terminal body portion 10a, an end portion opposite to the electric wire connection portion 10b is opened in a horizontally long rectangular shape. An opening 13 in this portion is an insertion portion into which a mating terminal is inserted.

Hereinafter, for convenience of description, a direction in which the terminal fitting 10 extends (a direction in which the terminal fitting 10 extends long) when the terminal fitting is mounted inside the housing 11 is referred to as a "front-rear direction". In addition, in the front-rear direction, a side on which the opening 13 of the terminal fitting 10 faces is referred to as a "front", and a side opposite to the "front" is referred to as a "rear". Further, a direction in which the width of the opening 13 of the terminal fitting 10 increases when the terminal fitting 10 is mounted inside the housing 11 is referred to as a "width direction". In addition, one side in a direction orthogonal to the front-rear direction and the width direction is referred to as "upper", and the other side is referred to as "lower".

An arrow UP pointing upward, an arrow FR pointing forward, and an arrow LH pointing leftward (leftward toward the front) are illustrated at appropriate positions in the drawing.

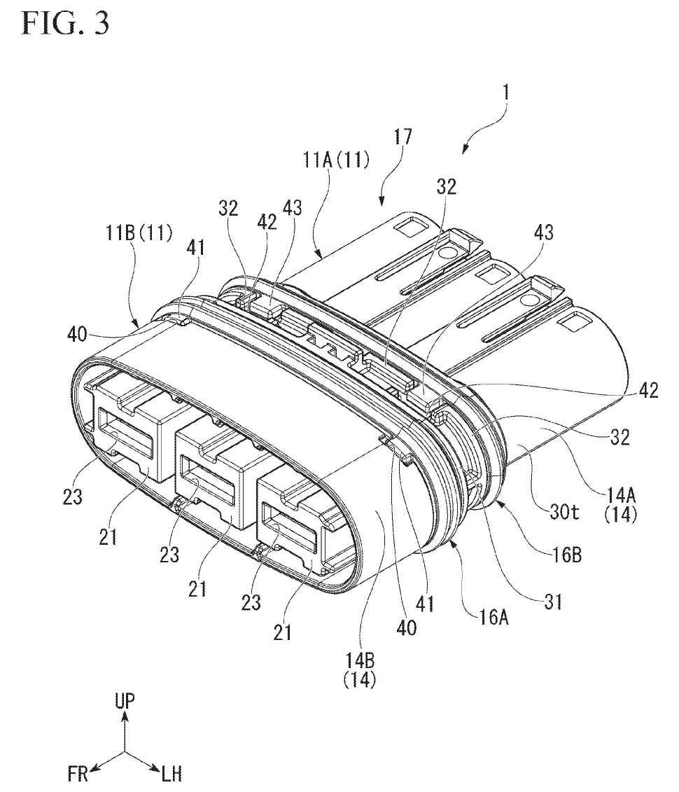

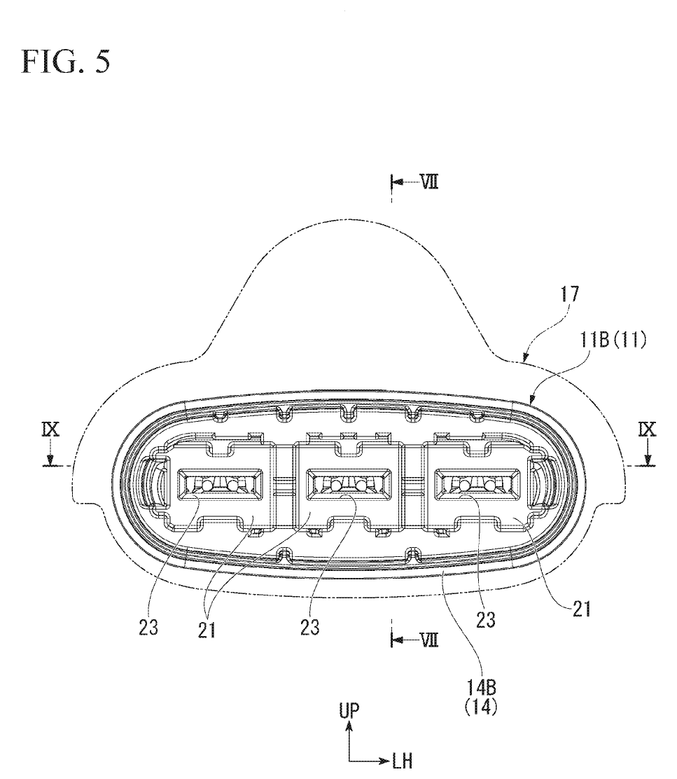

FIG. 3 is a perspective view of the connector 1 from which the connector cover 17 is removed. FIG. 4 is a plan view of the connector 1 in which the connector cover 17 is removed and the cover 60 of the mating connector is indicated by a virtual line. FIG. 5 is a front view of the connector 1 in which the connector cover 17 is indicated by a virtual line. The housing 11 includes a first housing 11A to which the connector cover 17 is attached on an outer peripheral surface, and a second housing 11B coupled to a front end portion of the first housing 11A. The first housing 11A and the second housing 11B are constituted as separate members. Both the first housing 11A and the second housing 11B are made of a resin material. The first housing 11A includes a first peripheral wall 14A constituting part (front region) of the peripheral wall 14. The second housing 11B includes a second peripheral wall 14B constituting a remaining part (rear region) of the peripheral wall 14.

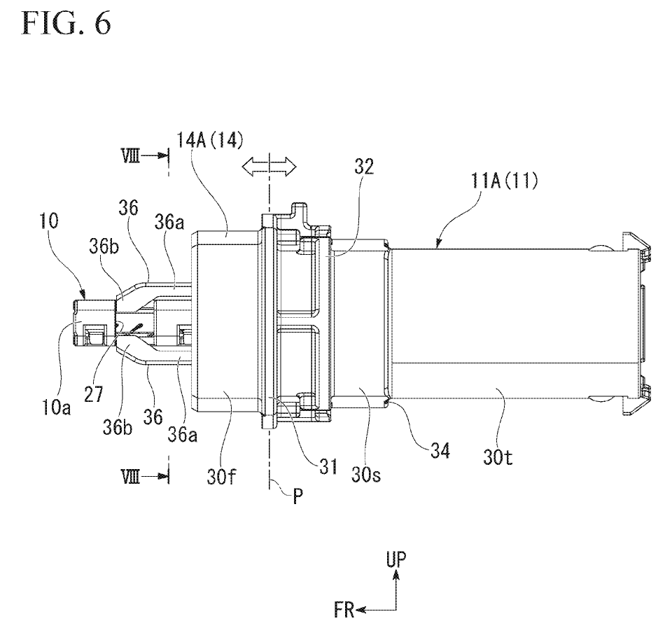

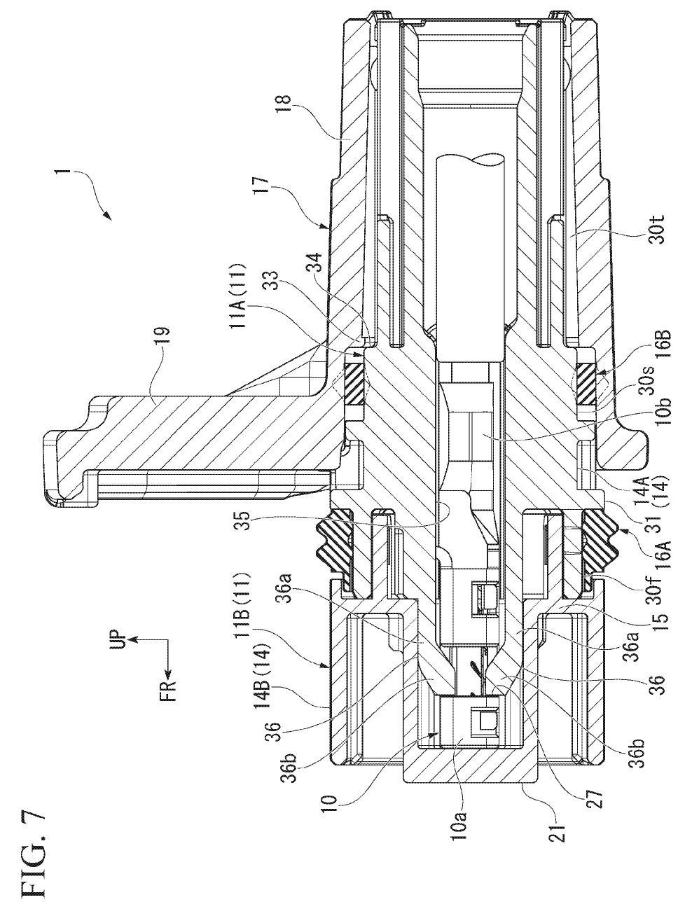

FIG. 6 is a side view of the connector 1 from which the second housing 11B and the connector cover 17 are removed. FIG. 7 is a cross-sectional view corresponding to the VII-VII cross section of FIG. 5.

As illustrated in FIGS. 2 and 7, a first seal member 16A and a second seal member 16B are mounted on the outer peripheral surface of the first peripheral wall 14A of the first housing 11A so as to be separated from each other in the front-rear direction. The first seal member 16A and the second seal member 16B are both formed in an elliptical annular shape. The fitting hole 61 (see FIG. 4) of the cover 60 of the mating connector is fitted to the outer peripheral surface of the first peripheral wall 14A near the front portion. The first seal member 16A seals a space between the outer peripheral surface of the first peripheral wall 14A near the front portion and the fitting hole 61 of the cover 60 of the mating connector. A cylindrical portion 18 of the connector cover 17 is fitted to the outer peripheral surface of the first peripheral wall 14A near the rear portion. The second seal member 16B seals a space between the outer peripheral surface of the first peripheral wall 14A near the rear portion and the cylindrical portion 18 of the connector cover 17.

Note that reference number 19 in FIGS. 1, 2, and 7 denotes a flange portion for fastening provided in the connector cover 17. A flange portion 19 abuts a cover 60 of a mating connector (not illustrated). The flange portion 19 and the cover 60 of the mating connector are fixed to each other by a fastening member such as a bolt 20.

The outer peripheral surface of the first peripheral wall 14A of the first housing 11A includes a first base surface 30f near the front portion having the longest peripheral length, a third base surface 30t near the rear portion having the shortest peripheral length, and a second base surface 30s in an intermediate region having a peripheral length shorter than that of the first base surface 30f and longer than that of the third base surface 30t. An annular restriction bead 31 is formed between the first base surface 30f and the second base surface 30s. The restriction bead 31 bulges toward the outer peripheral side with respect to the first base surface 30f and the second base surface 30s. The first seal member 16A is attached to the portion of the first base surface 30f. The displacement of the first seal member 16A mounted on the first base surface 30f toward the rear side (the side separated from the attachment mating member) is restricted by the restriction bead 31.

In addition, an auxiliary bead 32 intermittently extending along the circumferential direction of the first peripheral wall 14A is formed on the second base surface 30s at a position spaced apart from the restriction bead 31 on the rear side by a predetermined distance. The auxiliary bead 32 bulges toward the outer peripheral side of the second base surface 30s. The second seal member 16B is mounted on a region of the second base surface 30s on the rear side of the auxiliary bead 32. The displacement of the second seal member 16B attached to the second base surface 30s toward the front side is restricted by the auxiliary bead 32.

The peripheral length of the outer peripheral surface of the second peripheral wall 14B of the second housing 11B is longer than the peripheral length of the first base surface 30f of the first housing 11A and is substantially the same as the peripheral length of the outer peripheral surface of the restriction bead 31. Therefore, when the second housing 11B is coaxially coupled to the front portion of the first housing 11A, the second peripheral wall 14B bulges outward with respect to the first base surface 30f by substantially the same height as the restriction bead 31. The second peripheral wall 14B restricts displacement of the first seal member 16A toward the front side (the side close to the attachment mating member) in a state where the second housing 11B is coupled to the first housing 11A.

In addition, as illustrated in FIG. 7, an annular rib 33 protruding inward is provided in a protruding manner on the inner peripheral surface of the cylindrical portion 18 of the connector cover 17. When the connector cover 17 is attached to the first housing 11A, the annular rib 33 protrudes at a position facing (close to) a step surface 34 between the second base surface 30s and the third base surface 30t of the first peripheral wall 14A. The annular rib 33 restricts displacement of the second seal member 16B toward the rear side in a state where the connector cover 17 is attached to the first housing 11A.

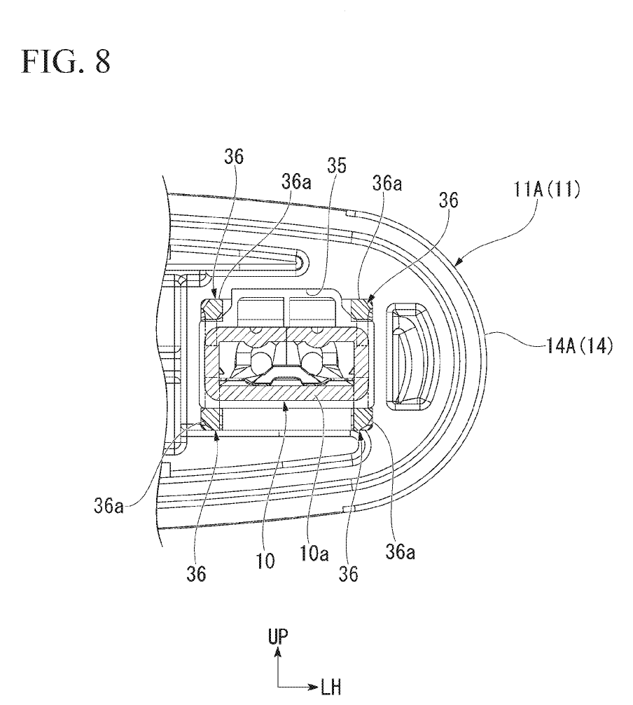

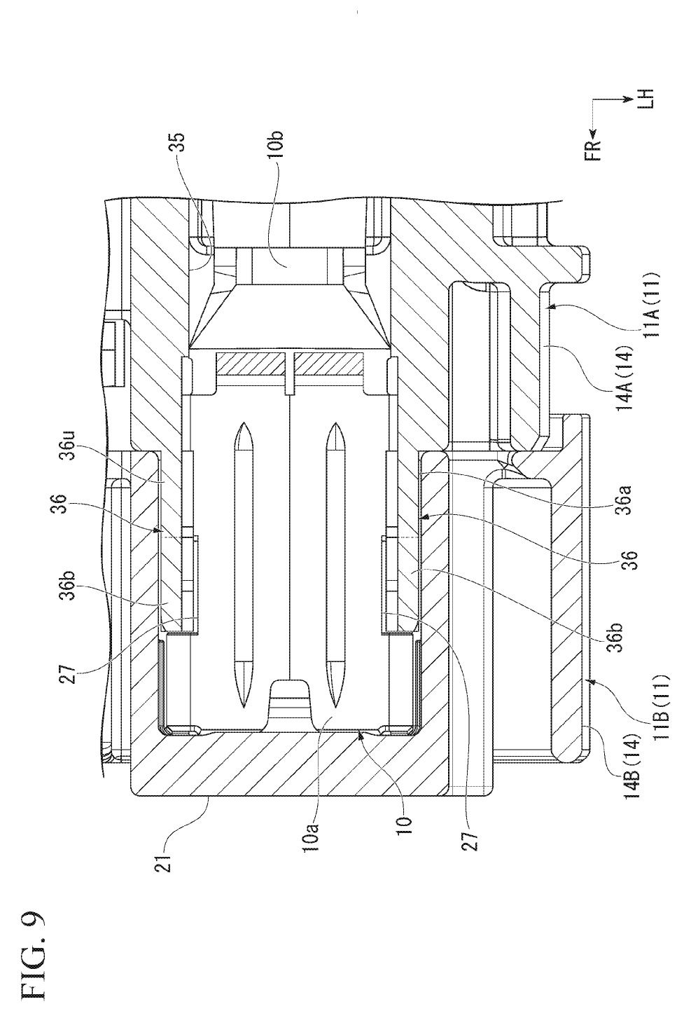

FIG. 8 is a cross-sectional view corresponding to the VIII-VIII cross section of FIG. 6. In addition, FIG. 9 is a cross-sectional view corresponding to the IX-IX cross section of FIG. 5.

As illustrated in FIG. 7, an insertion hole 35 through which the terminal fitting 10 and part of the electric wire W are inserted from the rear side is formed in the first housing 11A. Three insertion holes 35 are provided side by side in a line at a central position in the up-down direction of the first housing 11A. The cross-sectional shape of the front region of the insertion hole 35 is formed in a rectangular shape substantially along the outer surface shape of the terminal fitting 10. Two locking claws 36 protrude from each of the upper edge portion and the lower edge portion of the rectangular opening at the front end portion of each insertion hole 35. The locking claw 36 protruding from the upper edge portion includes a base portion 36a linearly extending forward from the upper edge portion, and an inclined claw portion 36b inclined downward from the tip of the base portion 36a toward the front. The locking claw 36 protruding from the lower edge portion includes the base portion 36a and the inclined claw portion 36b similarly to the locking claw 36 of the upper edge portion. However, the inclined claw portion 36b of the locking claw 36 of the lower edge portion is inclined upward from the tip of the base portion 36a toward the front side.

As illustrated in FIG. 8, two locking claws 36 protruding from the upper edge portion are arranged near two upper corner portions of the rectangular opening of the insertion hole 35. The two locking claws 36 protruding from the lower edge portion are arranged near two lower corner portions of the rectangular opening of the insertion hole 35. The upper two locking claws 36 and the lower two locking claws 36 are arranged to face each other so as to form a pair in the up-down direction.

As illustrated in FIGS. 2, 7, and 9, in the terminal fitting 10, recess portions 27 having a substantially rectangular shape in a top view are formed at left and right side edge portions of the terminal body portion 10a. The recess portion 27 is formed at a substantially central position in the front-rear direction (longitudinal direction) of the terminal body portion 10a. The recess portion 27 is recessed in a rectangular shape inward in the width direction from the side end surface of the terminal body portion 10a. Each terminal fitting 10 is inserted into the corresponding insertion hole 35 of the first housing 11A from the rear side when being mounted inside the housing 11. At this time, the terminal fitting 10 partially protruding forward from the front end portion of the insertion hole 35 is locked to the upper and lower locking claws 36. Specifically, the tips of the inclined claw portions 36b of the two pairs of upper and lower locking claws 36 enter the corresponding recess portions 27 of the terminal fitting 10 and are engaged with the recess portion 27. Thus, each terminal fitting 10 is temporarily held by the four locking claws 36.

The inclined claw portion 36b of each locking claw 36 is inclined toward the side facing the outer surface of the terminal fitting 10 toward the front side (the tip side in the extending direction). Therefore, when the terminal fitting 10 enters between the inclined claw portions 36b of the upper and lower locking claws 36 from the rear side, the upper and lower inclined claw portions 36b smoothly engage with the corresponding recess portions 27 of the terminal fitting 10.

When the second housing 11B is subsequently coupled to the first housing 11A, the terminal fitting 10 is more firmly locked by the four locking claws 36. A mechanism of this locking will be described later.

In the present embodiment, the locking claw 36 constitutes a terminal restriction portion that restricts displacement of the terminal fitting 10 in the front-rear direction (displacement in a direction along the extending direction of the first peripheral wall 14A).

As illustrated in FIG. 7, the second housing 11B includes a partition wall 15 that separates the inside of the second peripheral wall 14B in the front-rear direction. A terminal holding portion 21 into which the terminal body portion 10a of the terminal fitting 10 is inserted from the rear side is integrally formed on the partition wall 15. Three terminal holding portions 21 are provided side by side in a row at the center position of the partition wall 15 in the up-down direction. The terminal holding portion 21 is formed in a horizontally long rectangular parallelepiped shape. A part of the terminal holding portion 21 is formed to protrude toward the front side of the partition wall 15. The three terminal holding portions 21 are arranged at regular intervals in the width direction. In addition, on the front surface of each terminal holding portion 21, a horizontally long rectangular insertion port 23 into which a mating terminal (not illustrated) is inserted is formed. The mating terminal (not illustrated) is inserted into the terminal fitting 10 arranged in the terminal holding portion 21 through the insertion port 23.

In addition, the four locking claws 36 temporarily holding the terminal fitting 10 as described above are inserted into the corresponding terminal holding portion 21 as illustrated in FIGS. 7 and 9 when the second housing 11B is attached to the first housing 11A. At this time, in each locking claw 36, the outer surface of the base portion 36a abuts the inner wall of the terminal holding portion 21. As a result, the bending of the base portion 36a of each locking claw 36 is restricted, and the inclined claw portion 36b is firmly pushed into the recess portion 27 of the terminal fitting 10. As a result, the terminal fitting 10 is firmly locked by the four locking claws 36.

In addition, as illustrated in FIGS. 1 to 3, a recess portion 40 opened toward the rear side is formed in a rear edge portion of the second peripheral wall 14B of the second housing 11B. A plurality of recess portions 40 is formed in the peripheral region of the second peripheral wall 14B. In the first seal member 16A mounted on the first peripheral wall 14A of the first housing 11A, a rectangular convex portion 41 to be fitted with the recess portion 40 on the second peripheral wall 14B side is formed. In the first seal member 16A, when the second housing 11B is coupled to the front portion of the first housing 11A, the plurality of convex portions 41 are fitted into the corresponding recess portions 40. The first seal member 16A is thereby prevented from rotating with respect to the housing 11.

In addition, the auxiliary bead 32 formed on the first peripheral wall 14A is provided with a slit 42. The plurality of slits 42 is arranged along the circumferential direction of the first peripheral wall 14A. In the second seal member 16B mounted on the first peripheral wall 14A, a rectangular convex portion 43 to be fitted into the slit 42 of the auxiliary bead 32 is formed. In the second seal member 16B, when the connector cover 17 is attached to the first housing 11A, the plurality of convex portions 43 are fitted into the corresponding slits 42. The second seal member 16B is thereby prevented from rotating with respect to the housing 11.

### Effects of connector

In the connector 1 of the present embodiment, the housing 11 includes the first housing 11A and the separate second housing 11B coupled to the first housing 11A. The first housing 11A is provided with the first peripheral wall 14A, the restriction bead 31, and a terminal restriction portion (locking claw 36). The restriction bead 31 protrudes from the outer periphery of the first peripheral wall 14A to restrict rearward displacement of the seal member (first seal member 16A). The terminal fitting 10 is restricted from being displaced in the direction along the front-rear direction by the terminal restriction portion (locking claw 36) of the first housing 11A. In addition, the second housing 11B is provided with the second peripheral wall 14B and the terminal holding portion 21. The second peripheral wall 14B restricts forward displacement of the seal member (first seal member 16A). The terminal fitting 10 is inserted into the terminal holding portion 21.

In the case of the connector 1 of the present embodiment, the terminal fitting 10 can be engaged with the terminal restriction portion (locking claw 36) of the first housing 11A before the second housing 11B is coupled to the first housing 11A. Since the terminal restriction portion (locking claw 36) can have a structure integrated with the first housing 11A, it is not necessary to adopt a structure in which the terminal restriction block is inserted into the housing from a direction intersecting the extending direction of the terminal fitting 10. Therefore, in a case where this constitution is adopted, even in a structure in which the first seal member 16A and the restriction bead 31 are arranged on the outer periphery of the housing 11, displacement along the extending direction of the terminal fitting 10 can be reliably restricted.

In addition, in the case of the connector 1 of the present embodiment, the displacement of the seal member (first seal member 16A) in the front-rear direction is restricted by the restriction bead 31 on the first peripheral wall 14A of the first housing 11A and the second peripheral wall 14B of the second housing 11B. With this constitution, when the first housing 11A is molded, a molding die in which a parting line P (see FIG. 6) is orthogonal to the axial direction of the first peripheral wall 14A can be used. Therefore, in a case where this constitution is adopted, the seal member (first seal member 16A), in which a parting line along the axial direction does not occur on the outer surface of the first peripheral wall 14A, can be favorably brought into close contact with the first peripheral wall 14A.

Therefore, in a case where the connector 1 of the present embodiment is adopted, the displacement of the terminal fitting 10 along the extending direction can be reliably restricted, and the seal member (first seal member 16A) can be favorably brought into close contact with the peripheral wall of the housing 11.

In addition, in the connector 1 of the present embodiment, the recess portion 27 recessed in the direction intersecting the extending direction of the terminal fitting 10 is provided on the outer surface of the terminal fitting 10, and the terminal restriction portion is constituted by the locking claw 36 inserted and engaged with the recess portion 27. Therefore, in a case where the present structure is adopted, displacement along the extending direction of the terminal fitting 10 can be reliably restricted with a simple constitution.

Furthermore, in the connector 1 of the present embodiment, the locking claw 36 extends toward the front side along the extending direction of the first peripheral wall 14A and is inclined toward the side facing the outer surface of the terminal fitting 10 toward the tip side in the extending direction. With this constitution, when the terminal fitting 10 is inserted into the first housing 11A from the rear side, the outer surface of the terminal fitting 10 abuts the locking claw 36, and the locking claw 36 is smoothly bent and deformed outward. In addition, when the insertion of the terminal fitting 10 proceeds and the tip side of the locking claw 36 reaches the position of the recess portion 27 of the terminal fitting 10, the tip side of the locking claw 36 elastically returns and is engaged with the recess portion 27 of the terminal fitting 10.

Therefore, in a case where this constitution is adopted, the locking claw 36 serving as the terminal restriction portion can be easily engaged with the recess portion 27 of the terminal fitting 10, and the assembling workability is improved.

In addition, in the connector 1 of the present embodiment, at least a pair of the locking claws 36 is disposed at positions facing each other with the terminal fitting 10 interposed therebetween. In this constitution, when the terminal fitting 10 is inserted into the first housing 11A, the pair of locking claws 36 is bent and deformed in opposite directions. In this way, when the insertion of the terminal fitting 10 progresses, the tip side of each locking claw 36 elastically returns and is engaged with the corresponding recess portion 27 of the terminal fitting 10. As a result, the pair of locking claws 36 is engaged with the recess portion 27 of the terminal fitting 10, and in this state, the terminal fitting 10 is pressed from the opposite direction.

Therefore, in a case where this constitution is adopted, the terminal fitting 10 can be more stably supported by the locking claw 36.

In addition, in the connector 1 of the present embodiment, the locking claw 36 is inserted into the terminal holding portion 21 together with the terminal fitting 10 in a state of being engaged with the recess portion 27 of the terminal fitting 10, and comes into contact with the wall surface of the terminal holding portion 21 to restrict the bending displacement. In this case, the locking claw 36 engaged with the recess portion 27 of the terminal fitting 10 is inserted into the terminal holding portion 21 together with the terminal fitting 10. When the locking claw 36 abuts the wall surface of the terminal holding portion 21 in this state, the bending deformation of the locking claw 36 is restricted by the wall surface of the terminal holding portion 21.

Therefore, in a case where this constitution is adopted, it is possible to more reliably restrict the displacement of the terminal fitting with a simple constitution.

Although the embodiment of the present disclosure has been described above, the embodiment is shown as an example and is not intended to limit the scope of the present disclosure. This embodiment can be implemented in various other forms, and various omissions, substitutions, and changes can be made without departing from the gist of the present disclosure.

For example, in the above embodiment, each terminal fitting 10 is locked by the four locking claws 36, but the number of the locking claws 36 for locking the terminal fitting 10 is not limited to four. The number of locking claws 36 may be three or less or five or more as long as the terminal fittings 10 can be satisfactorily locked.

In addition, the terminal restriction portion may not necessarily have a claw shape like the locking claw 36. The terminal restriction portion may be any one as long as the terminal fitting 10 can be locked to the first housing 11A before the first housing 11A and the second housing 11B are coupled.

### Reference Signs List

1 CONNECTOR

10 TERMINAL FITTING

11 HOUSING

11A FIRST HOUSING

11B SECOND HOUSING

14 PERIPHERAL WALL

14A FIRST PERIPHERAL WALL

14B SECOND PERIPHERAL WALL

16A FIRST SEAL MEMBER (SEAL MEMBER)

21 TERMINAL HOLDING PORTION

27 RECESS PORTION

31 RESTRICTION BEAD

36 LOCKING CLAW (TERMINAL RESTRICTION PORTION)

W ELECTRIC WIRE

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A connector comprising:
a terminal fitting connected to an electric wire;
a housing having a peripheral wall in which a fitting hole of an attachment mating member is fitted on an outer side, and in which the terminal fitting is locked; and
a seal member that is mounted on an outer side of the peripheral wall of the housing and seals a space between the peripheral wall and the fitting hole,
the housing includes:
a first housing, and
a separate second housing coupled to the first housing,
the first housing includes:
a first peripheral wall constituting part of the peripheral wall,
a restriction bead protruding from an outer periphery of the first peripheral wall to restrict displacement of the seal member on a side away from the attachment mating member, and
a terminal restriction portion that restricts displacement of the terminal fitting in a direction along an extending direction of the first peripheral wall, and
the second housing includes:
a second peripheral wall that constitutes a remaining part of the peripheral wall and restricts displacement of the seal member on a side close to the attachment mating member in a state of being coupled to the first housing, and
a terminal holding portion into which the terminal fitting is inserted.

2. The connector according to claim 1, wherein
a recess portion recessed in a direction intersecting with an extending direction of the terminal fitting is provided on an outer surface of the terminal fitting, and
the terminal restriction portion includes a locking claw inserted into the recess portion and engaged with the recess portion.

3. The connector according to claim 2, wherein
the locking claw extends toward a side close to the attachment mating member along an extending direction of the first peripheral wall and is inclined toward a side facing the outer surface of the terminal fitting toward a tip side in the extending direction.

4. The connector according to claim 3, wherein
at least a pair of the locking claws is provided at positions facing each other with the terminal fitting interposed between.

5. The connector according to claim 3, wherein
the locking claw is inserted into the terminal holding portion together with the terminal fitting in a state of being engaged with the recess portion of the terminal fitting, and comes into contact with a wall surface of the terminal holding portion to restrict bending displacement.

6. The connector according to claim 4, wherein
the locking claw is inserted into the terminal holding portion together with the terminal fitting in a state of being engaged with the recess portion of the terminal fitting, and comes into contact with a wall surface of the terminal holding portion to restrict bending displacement.
